(19) United States
(12) Patent Application Publication
(10) Pub. No.: US 2018/0033028 A1
(43) Pub. Date: Feb. 1, 2018

(54) SELF CHARGING SHOPPING CART AND CUSTOMER INTEREST TRACKER

(71) Applicant: Wal-Mart Stores, Inc., Bentonville, AR (US)

(72) Inventors: Venugopal E. Puthalath, Bentonville, AR (US); Kevin M. Charles, Bentonville, AR (US)

(21) Appl. No.: 15/659,806

(22) Filed: Jul. 26, 2017

Related U.S. Application Data
(60) Provisional application No. 62/367,378, filed on Jul. 27, 2016.

(51) Int. Cl. G06Q 30/02; B60K 1/00; G06Q 10/08; G07G 1/00; G06Q 30/06; G06Q 20/20

(52) U.S. Cl. CPC G06Q 30/0201; G06Q 30/06; G06Q 20/20; G06Q 10/0875; G07G 1/0036; B60K 1/00

(57) ABSTRACT

Embodiments relate to systems and methods for determining customer interests in a retail environment. In one embodiment, a system includes a receptacle module coupled to a shopping receptacle, a shopping receptacle tracking system, and a customer interest engine. The shopping receptacle tracking system installed in the retail environment communicates with the receptacle module to receive customer information and shopping receptacle location information. The customer interest engine and coupled point-of-sale system can correlate data from the shopping receptacle tracking system to identify customer interests related to the retail environment. Portions of the shopping receptacle can power the circuitry for the receptacle module.

### RELATED APPLICATION

The present application claims the benefit of U.S. Provisional Application No. 62/367,378 filed Jul. 27, 2016, which is hereby incorporated herein in its entirety by reference.

### TECHNICAL FIELD

Embodiments relate generally to retail management systems and more particularly to systems and methods for customer tracking based on power-generating shopping receptacles.

### BACKGROUND

Retailers often utilize customer tracking within a retail location to efficiently staff and stock their stores, and to provide targeted advertising to particular customers based on their activity in the store. Traditional customer tracking systems that utilize the customer's mobile device are undesirable because they are dependent upon those devices.

Shopping receptacles, such as shopping carts, can be fitted with tracking devices for retail location customer tracking. However, traditional power systems needed for powering such tracking devices are inefficient and costly to charge. For example, a cart may need to be physically plugged in to an electrical outlet or charging station after each use in order to maintain power for the tracking device.

### SUMMARY

In an embodiment, a system for determining customer interests in a retail environment comprises a shopping receptacle module configured to be coupled to a shopping receptacle and comprising an energy capture portion and a communications portion, the energy capture portion comprising an energy storage device configured to receive and store energy generated by movement of the shopping receptacle, and the communications portion comprising customer identification circuitry and wireless transmitter circuitry and being electrically coupled with the energy storage device to receive power therefrom; a shopping receptacle tracking system configured to be installed in the retail environment and comprising wireless communications circuitry configured to receive customer identification information and shopping receptacle location information from the wireless transmitter circuitry and track movement of the shopping receptacle in the retail environment over time; and a customer interest engine communicatively coupled with a point-of-sale (POS) system in the retail environment and the shopping receptacle tracking system and configured to correlate data from the POS system with the customer identification information and the tracked movement of the shopping receptacle in the retail environment over time to identify at least one customer interest related to the retail environment for a customized follow-up action.

In an embodiment, a method for determining customer interests in a retail environment comprises providing a shopping receptacle module configured to be coupled to a shopping receptacle and comprising an energy capture portion and a communications portion, the energy capture portion comprising an energy storage device configured to receive and store energy generated by movement of the shopping receptacle, and the communications portion comprising customer identification circuitry and wireless transmitter circuitry and being electrically coupled with the energy storage device to receive power therefrom; providing a shopping receptacle tracking system configured to be installed in the retail environment and comprising wireless communications circuitry configured to receive customer identification information and shopping receptacle location information from the wireless transmitter circuitry and track movement of the shopping receptacle in the retail environment over time; and providing a customer interest engine communicatively coupled with a point-of-sale (POS) system in the retail environment and the shopping receptacle tracking system and configured to correlate data from the POS system with the customer identification information and the tracked movement of the shopping receptacle in the retail environment over time to identify at least one customer interest related to the retail environment for a customized follow-up action.

In an embodiment, a method for determining customer interests in a retail environment comprises associating a customer with a shopping receptacle; tracking movement of the shopping receptacle in a retail environment during a period of time, wherein the movement generates energy that is captured and used by at least one electrical device mounted on the shopping receptacle; correlating data from a purchase made in the retail environment by the customer with the tracking based at least in part on data obtained in the associating; and identifying, from the correlating, at least one customer interest related to the retail environment for a customized follow-up action.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIGS. 1A and 1B are block diagrams of a system for determining customer interests in a retail environment according to an embodiment.

FIG. 2 is a block diagram of a shopping receptacle according to an embodiment.

FIG. 3 is a block diagram of another embodiment of a receptacle module subsystem.

FIG. 4 is a flowchart of a method for determining customer interests in a retail environment according to an embodiment.

FIG. 5 is a diagram of a retail store in which the system of FIGS. 1A and 1B can be deployed, according to an embodiment.

FIG. 6 is a flowchart of another method for determining customer interests in a retail environment according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

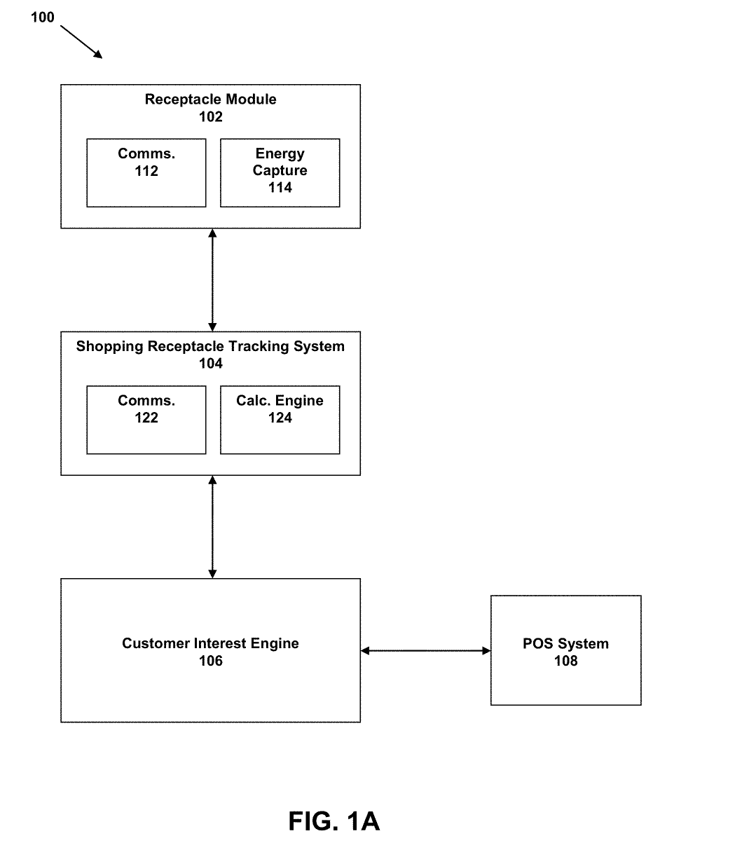

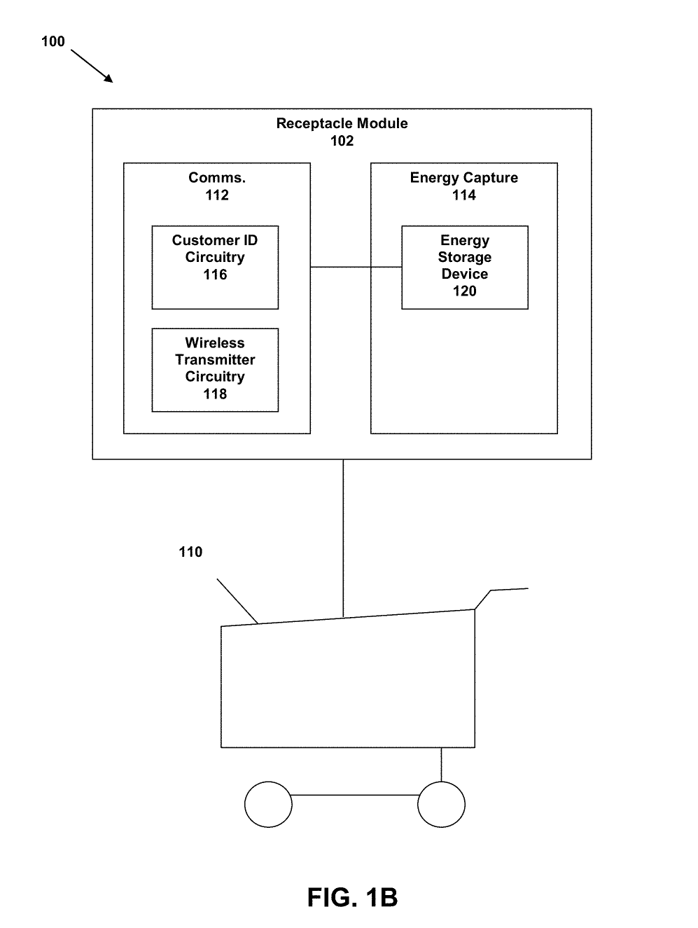

Referring to FIGS. 1A and 1B, a system 100 for determining customer interests in a retail environment is depicted. In an embodiment, system 100 comprises a receptacle module 102, a shopping receptacle tracking system 104, a customer interest engine 106, a point-of-sale (POS) system 108, and a shopping receptacle 110. System 100 can be deployed in almost any retail space, such as in a “big box,” warehouse, shopping center-based, neighborhood or other store.

Receptacle module 102 is configured to be coupled to a shopping receptacle such as shopping receptacle 110. In an embodiment, receptacle module 102 comprises a communications portion 112 and an energy capture portion 114.

Communications portion 112 is configured to receive or determine customer information and communicate such customer information to other elements of system 100. For example, as depicted in FIG. 1A, receptacle module 102 (and particularly communications portion 112) is in communication with shopping receptacle tracking system 104. Referring particularly to FIG. 1B, in one embodiment, communications portion 112 comprises customer identification circuitry 116 and wireless transmitter circuitry 118.

Customer identification circuitry 116 comprises one or more electronic elements configured to identify the customer operating shopping receptacle 110. For example, customer identification circuitry 116 can comprise a magnetic stripe reader, a BLUETOOTH module, a WIFI module, a keypad, a radio frequency identification (RFID) module, a near-field communication (NFC) antenna, a biometric identifier, or a chip-and-pin module. Other suitable modules or identifiers can likewise be utilized.

In one embodiment, customer identification circuitry 116 comprises a magnetic stripe reader configured to receive a swipe from a customer's loyalty or membership card.

In another embodiment, customer identification circuitry 116 comprises a BLUETOOTH module configured to receive data from a customer's correspondingly-enabled BLUETOOTH device, such as a mobile phone, tablet, or BLUETOOTH dongle.

In still another embodiment, customer identification circuitry 116 comprises display capabilities configured to display prompts or other interfaces to the customer to determine the customer's identity.

Wireless transmitter circuitry 118 comprises one or more electronic elements configured to transmit and receive data related to system 100. For example, wireless transmitter circuitry 118 can be configured for radio frequency (RF) communications, WIFI communications, BLUETOOTH communications, or near-field communications (NFC). Other suitable communication circuitries can likewise be utilized. In an embodiment, customer information determined by customer identification circuitry 116 can be transmitted to other elements of system 100, such as shopping receptacle tracking system 104 and its corresponding receiving elements. In other embodiments, information related to energy capture portion 114, such as energy storage amounts, energy usage amounts, and so on, can be transmitted to other elements of system 100, such as shopping receptacle tracking system 104 and its corresponding receiving elements. Similarly, wireless transmitter circuitry 118 can be configured to receive data related to system 100, and particularly, from shopping receptacle tracking system 104.

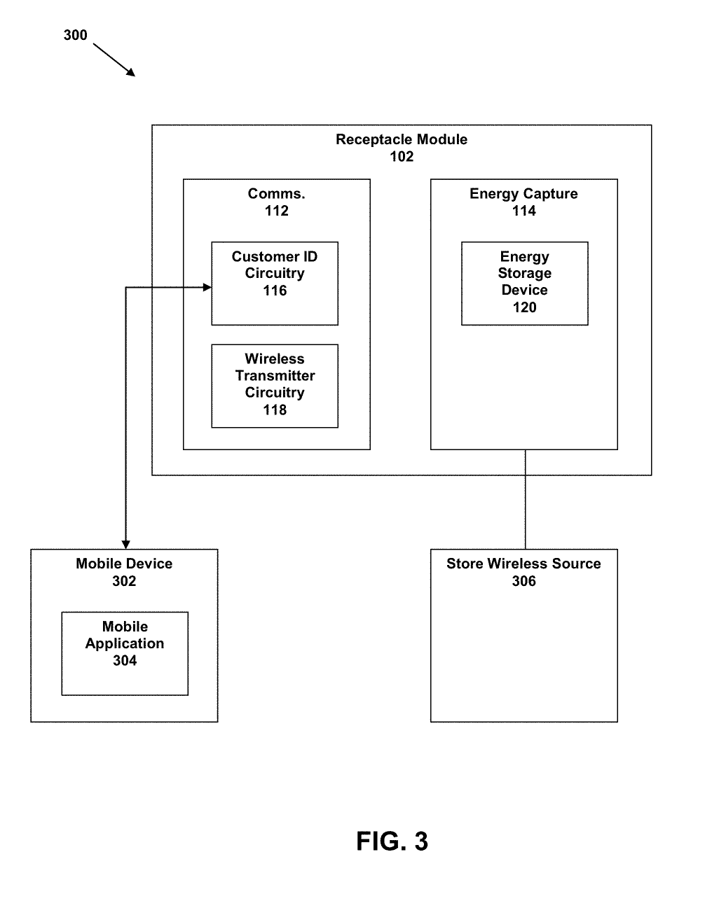

Energy capture portion 114 is configured to receive and store energy for the electronics of communications portion 112. In one embodiment as depicted in FIGS. 1A and 1B, energy capture portion 114 comprises an energy storage device 120 configured to receive and store energy generated by movement of shopping receptacle 110. In another embodiment, as will be described with respect to FIG. 3, energy capture portion 114 is configured to receive and store energy from other sources, such as wireless sources within the retail store. Energy storage device 120 can comprise a battery, capacitor, or other suitable accumulator.

Communications portion 112 can be electrically coupled with energy storage device 120 to receive power from energy storage device 120.

Referring again to FIG. 1A, shopping receptacle tracking system 104 comprises wireless communications circuitry 122 and a calculation engine 124. In an embodiment, shopping receptacle tracking system 104 is configured to track movement of shopping receptacle 110 in the retail environment over time. In embodiments, shopping receptacle tracking system 104 is configured to be installed in the retail environment. As shown in FIG. 1A, shopping receptacle tracking system 104 can be operably coupled to receptacle module 102 and customer interest engine 106.

Wireless communications circuitry 122 is configured to receive customer identification information and shopping receptacle 110 location information from wireless transmitter circuitry 118. Similar to wireless transmitter circuitry 118, wireless communications circuitry 122 can be configured for radio frequency (RF) communications, WIFI communications, BLUETOOTH communications, or near-field communications (NFC). Other suitable communication circuitries can likewise be utilized. In embodiments, both wireless transmitter circuitry 118 and wireless communications circuitry 122 are configured for the same wireless protocol.

Calculation engine 124 is configured to analyze location-related data received from the components of system 100 to track shopping receptacle 110. For example, calculation engine 124 is operably coupled to wireless communications circuitry 122 to collect the location data communications from wireless transmitter circuitry 118. In an embodiment, calculation engine 124 comprises a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that cause the engine to implement the particular functionality described herein.

Receptacle module 102 and shopping receptacle tracking system 104 can be configured such that a periodic exchange of shopping receptacle 110 location data occurs between wireless transmitter circuitry 118 and wireless communications circuitry 122. One skilled in the art will readily appreciate that if the communication rate between wireless transmitter circuitry 118 and wireless communications circuitry 122 is set to a predetermined rate, timing of the relative locations of shopping receptacle 110 can be readily determined. In other embodiments, the exchange of location data from wireless transmitter circuitry 118 and wireless communications circuitry 122 can be ad-hoc. In such embodiments, a timestamp or other time-field component can be included in the transmission message.

In an embodiment, shopping receptacle tracking system 104 requests a message transmission from each receptacle module 102 in the retail environment. For example, at a certain periodic rate determined by shopping receptacle tracking system 104, a request for location data can be sent. Upon receipt of the request, each receptacle module 102 (and particularly, each wireless transmitter circuitry 118) is configured to return the request with a data package containing at least location data of the receptacle module 102. In other embodiments, receptacle module 102 broadcasts its message without an initial request for data by shopping receptacle tracking system 104.

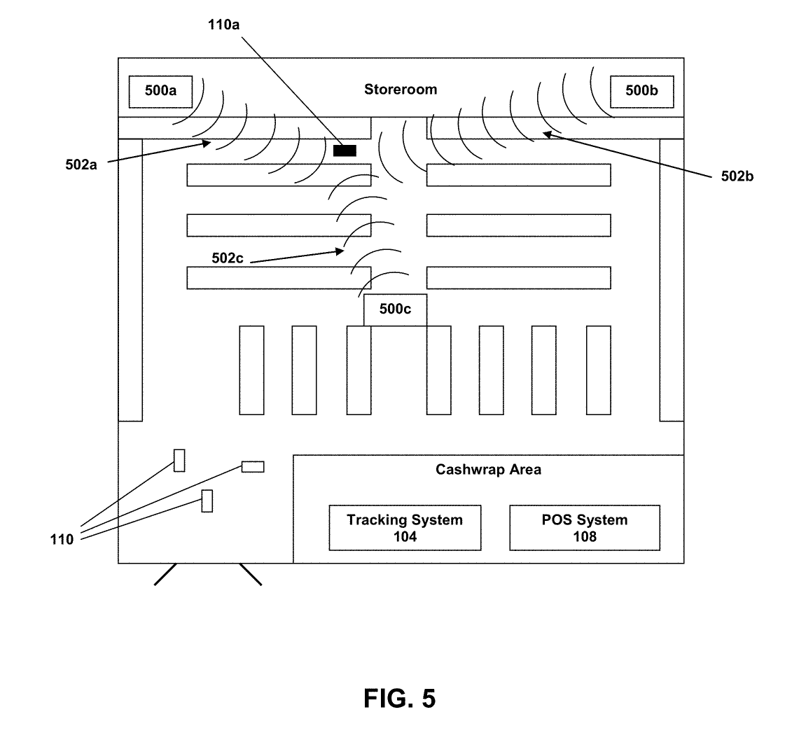

In still other embodiments, and as will be described further with respect to FIG. 5, shopping receptacle tracking system 104 can utilize “pings” or other passive data collection methods targeted at receptacle module 102 (and particularly, wireless transmitter circuitry 118) to determine the location of shopping receptacle 110. For example, a store Wi-Fi system can determine the relative location of a particular wireless transmitter circuitry 118 within the store based on, among other indicators, the intensity of the received signal relative to various wireless access points. Wi-Fi triangulation can thus be utilized to determine the relative location of a particular wireless transmitter circuitry 118. In another embodiment, other geo-location systems or methods can be utilized, such as radio frequency (RF) location methods.

Calculation engine 124 is configured to take the data received from wireless transmitter circuitry 118 and perform parsing, aggregation, or other data manipulation as necessary to determine relative locations and timings of those locations of shopping receptacle 110 within the store. For example, if calculation engine 124 determines that five 1 Hz messages were received with the same shopping receptacle 110 location data, it can be determined that the customer was stationary at that location for 5 seconds. Of course, this simplistic example is used for ease of explanation only, and increasingly complex algorithms can be readily generated, with increasingly frequent data transmissions for additional location accuracy.

In embodiments, calculation engine 124 can generate a database, map, data point list, machine-readable output, or other suitable output of customer location or other data. In other embodiments, calculation engine 124 can be queried by, for example, customer interest engine 106 and return location, energy, or other data.

In an embodiment, shopping receptacle tracking system 104 is further configured to track energy data for shopping receptacle 110. For example, calculation engine 124 can be further configured to analyze energy-related data received from the components of system 100 to monitor shopping receptacle 110 energy data. For example, calculation engine 124 is operably coupled to wireless communications circuitry 122 to collect the energy data communications from wireless transmitter circuitry 118. In an embodiment, energy-related data can be combined in the same transmission package as location-related data. In other embodiments, energy-related data can be sent in a separate transmission package. Energy-related data can comprise usage levels, storage levels, generation efficiency levels, and the like. Energy-related data can be used to determine, for example, which carts may need energy storage device 120 repair or replacement, or shopping receptacle component repair or replacement.

Calculation engine 124 can likewise integrate customer identification information received by communications circuitry 122 into its data packages.

As depicted in FIG. 1A, in an embodiment, customer interest engine 106 can be communicatively coupled with POS system 108 and shopping receptacle tracking system 104. In general, customer interest engine 106 is configured to study a customer's shopping behavior by analyzing the time spent at different places within the store with actual purchases. In an embodiment, customer interest engine 106 can access actual purchases through transaction logs of POS system 108, as will be described.

In general, interests of the customer can be identified by the time spent (by the shopping receptacle) in the different aisles and specific departments or other points within the store.

In an embodiment, customer interest engine 106 can be configured to correlate data from POS system 108 with the customer identification information and the tracked movement of shopping receptacle 110 in the retail environment over time to identify at least one customer interest related to the retail environment for a customized follow-up action. For example, the customized follow-up action can be an offer to a customer for a product that the customer spent time near according to the tracked movement of the shopping receptacle in the retail environment over time but did not purchase. In embodiments, as will be described, data from POS system 108 and the customer identification information obtained from customer identification circuitry 116 can be utilized in generating a follow-up action. In an embodiment, the product complements a product purchased by the customer according to the data from POS system 108.

POS system 108 generally comprises the cash register, scanner, computer, tablet, or other devices used at cash wrap or checkout areas to tally and record customer purchases and accept payment. POS system can therefore record transaction logs (TLOG) of the various purchases. In some embodiments, shopping receptacle tracking system 104 and/or customer interest engine 106 can be partially or fully integrated with POS system 108. In an embodiment, a customer membership card associated with the retail environment can be interfaced with POS system 108. In some embodiments, the same customer membership card can be interfaced with customer identification circuitry 116 of receptacle module 102.

Shopping receptacle 110 can comprise any suitable repository for temporarily storing shopping items. Customers that visit a retail space often use a shopping receptacle to collect and carry items selected for purchase. Examples of shopping receptacles include shopping carts, baskets, rolling baskets, bags and others, and the general term “receptacle” will be used herein to refer to or include any suitable type of shopping receptacle.

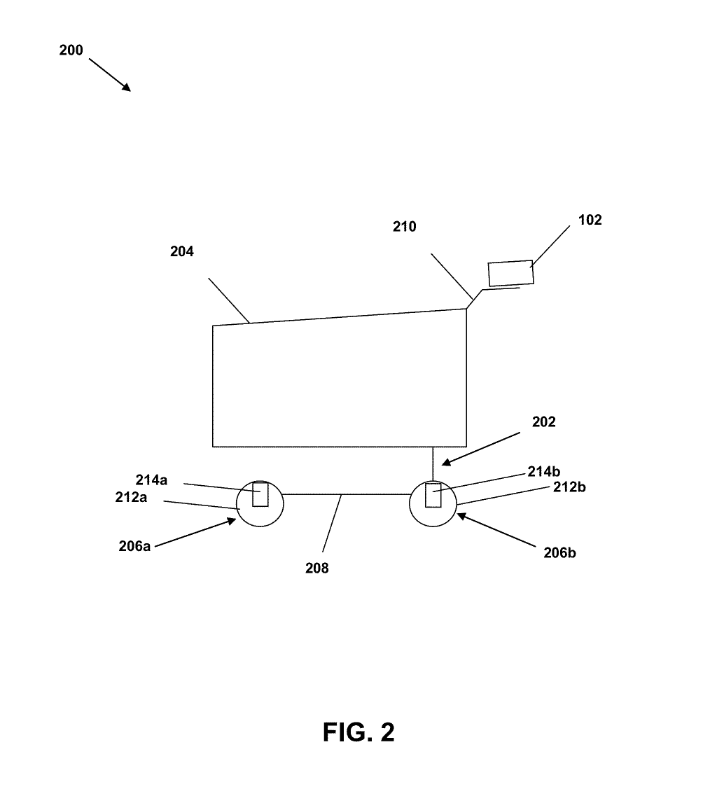

Referring to FIG. 2, a block diagram of a shopping receptacle 200 is depicted. In an embodiment, shopping receptacle 200 can be substantially similar to shopping receptacle 110. Shopping receptacle 200 comprises a frame 202, a retail item repository 204, and one or more wheel subsystems 206.

Frame 202 comprises the support structure that operably couples retail item repository 204 to wheel subsystems 206. In embodiments, frame 202 further provides the support structure for operably coupling a receptacle module such as receptacle module 102 to shopping receptacle 200.

In an embodiment, frame 202 comprises a wheel support 208 and a handle 210. Wheel support 208 can project from retail item repository 204 to one or more wheel subsystems 206 and support one or more wheel subsystems 206 such that each of the wheels of wheel subsystems 206 have space to rotate. Wheel support 208 can further comprise support structure between each of wheel subsystems 206. As such, frame 202, and in embodiments, wheel support 208 comprises one or more axles.

Handle 210 can project from retail item repository 204 to provide a support for steering or guiding shopping receptacle 200. As shown in FIG. 2, receptacle module 102 is operably coupled to handle 210. In other embodiments, receptacle module 102 can be operably coupled to shopping receptacle 200 in any suitable manner, such as by mounting, fastening, or adhering. In another embodiment, receptacle module 102 can be integrated into shopping receptacle 200, such as by seamless integration into frame 202, or more particularly, handle 212.

Retail item repository 204 comprises a container or other contained void for the customer to collect and carry items selected for purchase. For example, retail item repository 204 can comprise a grated basket.

Wheel subsystem 206 comprises a wheel 212 and an energy capture element 214. For example, referring to the left front wheel subsystem of shopping receptacle 200, wheel subsystem 206a comprises wheel 212a and energy capture element 214a.

Wheel 212a can be axially mounted on wheel support 208 such that it rotates when handle 210 is pushed by the user. Wheel 212a can comprise any suitable wheel type, such as rubber, plastic, metal, and the like.

Energy capture element 214a is configured to collect the energy created by the motion of wheel 212a. Energy capture element 214a can be operably coupled to wheel 212a and/or frame 202. In an embodiment, energy capture element 214a can comprise a friction-based collection system. For example, as wheel 212a turns by the pushing of shopping receptacle 200, friction is created and collected by energy capture element 214a. Energy capture element 214a therefore transforms mechanical energy into electrical energy. The captured electrical energy can be stored by, for example, receptacle module 101, and specifically, energy storage device 120.

As shown in FIG. 2, and referring to the left rear wheel subsystem of shopping receptacle 200, wheel subsystem 206b comprises wheel 212b and energy capture element 214b. In an embodiment, wheel subsystem 206b can be substantially similar to wheel subsystem 206a. Other wheel subsystems can likewise be provided for shopping receptacle 200 (though not shown in FIG. 2). In embodiments, energy capture elements can differ on the same shopping receptacle 200. For example, if the wheels of a shopping receptacle are slightly larger for the rear wheels, which create more friction when interfacing with the frame and floor surface, a different energy capture element can be utilized than for the smaller front wheels. In other embodiments, energy capture elements can be utilized on less than all of the wheels.

Other types of receptacles can similarly be utilized in embodiments. Rolling baskets can be implemented with the power generation components described with respect to FIG. 2. In other embodiments, receptacles without wheels can be integrated with power generation components. For example, hand-carried baskets can be integrated with kinetic movement capturing components, such as a rotor that turns on a pivot. The normal movements of the customer's arm carrying the basket causes the rotor to pivot on its staff such that energy can be captured by the repeated swaying of the rotor.

Referring to FIG. 3, a block diagram of another embodiment of a receptacle module subsystem 300 is depicted. Subsystem 300 generally comprises a receptacle module 102 as described with respect to FIGS. 1A and 1B. Subsystem 300 further depicts example interfaces and components that can be configured to interact with receptacle module 102. The interfaces and components depicted in FIG. 3 are provided by way of example only. In embodiments, portions of subsystem 300 can be used with other portions of the embodiments described in FIGS. 1-2, and vice versa.

For example, receptacle module 102 can interface with a mobile device. In particular, customer identification circuitry 116 is configured to communicate with customer mobile device 302. As described above with respect to wireless transmitter circuitry 118, customer mobile device 302 can likewise be configured for radio frequency (RF) communications, WIFI communications, BLUETOOTH communications, or near-field communications (NFC) to communicate customer identification data with customer identification circuitry 116.

In an embodiment, as customer mobile device 302 includes a mobile application 304 associated with the retail environment. Mobile application 304 can comprise a device-specific software application configured for operation on mobile device 302. For example, mobile application 304 can be a retail-location-specific or retailer-specific application. In an embodiment, mobile application 304 can receive customer information via a user interface of mobile device 302. Mobile application 304 can likewise communicate customer information to customer identification circuitry 116. In an embodiment, and referring again to FIG. 1A, customer interest engine 106 can be configured to be communicatively coupled with mobile application 304.

Store wireless source 306 comprises an alternative for powering the electronics of communications portion 112 or other components of system 100. Store wireless source 306 can comprise a wireless energy source within the retail location. Store wireless source 306 can be configured to interface with energy capture device 114 to receive energy suitable for powering communications portion 112. In an embodiment, store wireless source 306 comprises an RF or Wi-Fi source configured to provide wireless power. One skilled in the art will readily understand that store wireless source 306 can comprise any suitable transmission charging coil. In such embodiments, energy capture device 114 can comprise a corresponding receive coil. Multiple store wireless sources 306 can be placed around the retail location so receptacle module 102 is generally near one of the store wireless sources 306. Store wireless source 306 can be used independently of any shopping receptacle power generation systems or methods. Alternatively, store wireless source 306 can be used in combination with any shopping receptacle power generation systems or methods.

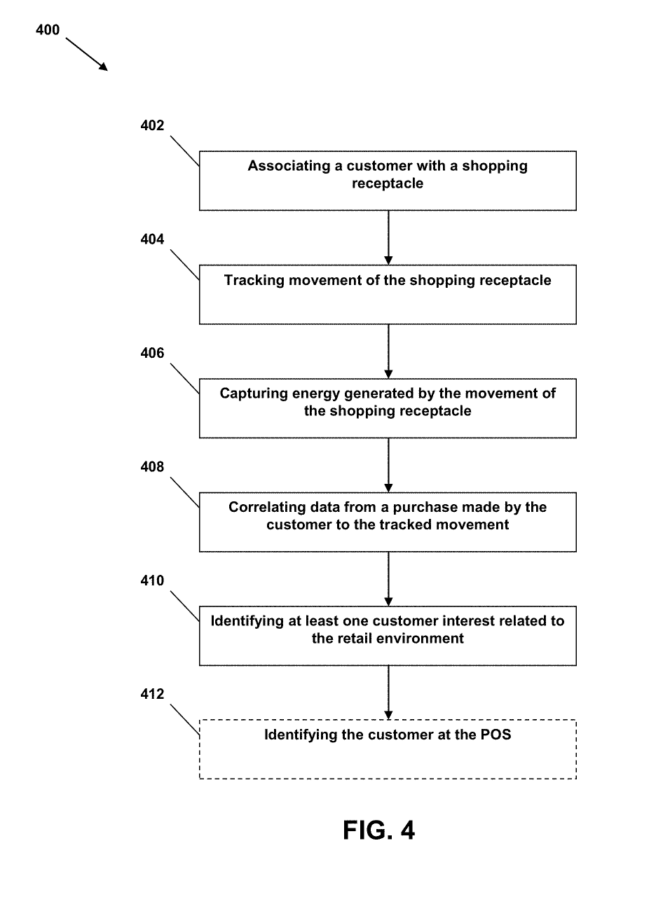

Referring to FIG. 4, a flowchart of a method 400 for determining customer interests in a retail environment is depicted according to an embodiment. Method 400 can be implemented by, for example, the components of system 100 as depicted in FIGS. 1A and 1B.

At 402, receptacle module 102 and shopping receptacle tracking system 104 can associate a customer with a particular shopping receptacle. For example, communications portion 112 of receptacle module 102 can receive or determine customer information and communicate the customer information to shopping receptacle tracking system 104. In particular, customer identification circuitry 116 identifies the customer operating the shopping receptacle and communicates this information to wireless communications circuitry 122 of shopping receptacle tracking system 104. Calculation engine 124 is configured to store an association between the customer and the particular shopping receptacle being used. In embodiments, shopping receptacles can include unique identifiers similarly passed from receptacle module to shopping receptacle tracking system 104. In an embodiment, the associating comprises receiving information identifying the customer as a member of the retail environment.

At 404, shopping receptacle tracking system 104 can track movement of the shopping receptacle. For example, referring to FIG. 5, a diagram of a retail store in which the system of FIGS. 1A and 1B can be deployed is depicted. Shopping receptacle tracking system 104 can utilize “pings” or other passive data collection methods targeted at receptacle module 102 (and particularly, wireless transmitter circuitry 118) to determine the location of shopping receptacle 110. Wireless access points 500 can be deployed at various locations around the store.

In FIG. 5, several shopping receptacles 110 are depicted. For ease of explanation, shopping receptacle 110a is highlighted to illustrate the tracking operation of system 100. Wireless access point 500a is positioned in one corner of the retail location. Wireless access point 500b is positioned in another corner of the retail location. Wireless access point 500c is positioned in the middle of the retail location. Of course, additional wireless access points can be deployed at additional or different locations depending on the particular circumstances of the retail location.

The relative distances between wireless access points 500a, 500b, and 500c and shopping receptacle can be determined by methods described above. Relative distances can be determined with respect to relative transmission distances 502a, 502b, and 502c in FIG. 5. Wireless transmitter circuitry 118 and/or wireless access points 500a-500c can transmit the location information to shopping receptacle tracking system 104, shown in FIG. 5 as within the cashwrap area. Of course, shopping receptacle tracking system 104 can be placed at any number of locations as desirable for the particular retail location. At a predetermined time, or when shopping receptacle 110a has been detected as having moved, wireless transmitter circuitry 118 and/or wireless access points 500a-500c can transmit second location information to shopping receptacle tracking system 104, and so on. In other embodiments, location information is not transmitted in “real time,” but is stored in the wireless access points 500a-500c or wireless transmitter circuitry 118 for later transmission to shopping receptacle tracking system 104.

Referring again to FIG. 4, at 406, energy capture portion 114 can capture the energy generated by the movement of the shopping receptacle.

At 408, customer interest engine 106 can correlate data from a purchase made by the customer to the tracked movement. For example, once the customer is finished shopping, the customer can purchase the items stored in the shopping receptacle at POS system 108. Therefore, in an embodiment, correlating data from a purchase to the tracked movement can comprise receiving purchase data from POS system 108 and associating the purchase data to the tracked movement of the customer relative to the items purchased. As such, every trip that a shopping receptacle makes in the store can be tagged to a receipt generated at POS system 108.

At 410, customer interest engine 106 can identify at least one customer interest related to the retail environment. For example, customer interest engine 106 can associate time spent near certain products or locations with actual purchases. If a customer spends a large amount of time near one section of the store, such as the produce department, that customer may be interested in healthy eating. Customer interests can therefore be derived.

Time increments can be determined relative to the customer. For example, for a customer spending ten minutes in the store, one minute spent at a location is a greater percentage of the overall shopping trip than one minute spent at a location for a customer spending thirty minutes in the store. In an embodiment, the at least one customer interest is a product that the customer spent time near but did not purchase according to the correlating. In embodiments, method 400 further comprises providing an offer to the customer for the product not purchased.

Optionally, at 412, the customer can be identified at the POS system. Identification at POS system 108 can allow for the retail location or POS system operator to have a more personal interaction with the customer, or to provide real-time offers or advertising. For example, the customer can be identified by a membership number or card, credit card XREF number lookup, or other identifier at the point-of-sale.

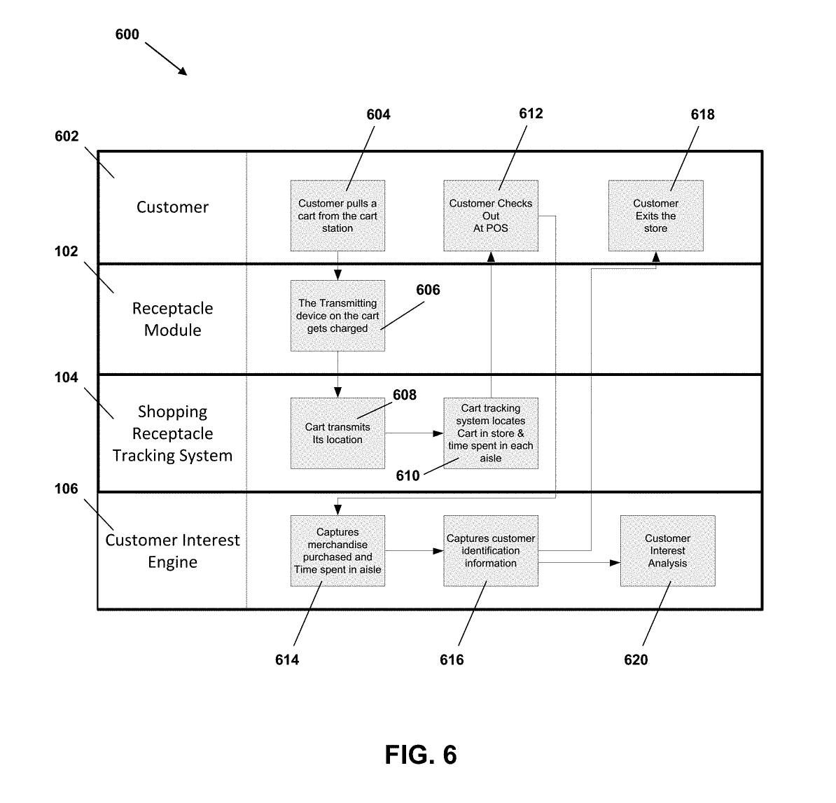

Referring to FIG. 6, another embodiment of a method 600 for determining customer interests in a retail environment is depicted. Method 600 can be implemented by, for example, the components of system 100 as depicted in FIGS. 1A and 1B. The respective tasks or responsibilities of receptacle module 102, shopping receptacle tracking system 104, and customer interest engine 106 are depicted in FIG. 6. Additionally, customer 602 is depicted for context in the retail location interaction with the components of system 100.

At 604, customer 602 obtains shopping receptacle 110 from a storage location. For example, customer 602 can pull a cart from a cart station. At 606, receptacle module 102 charges the transmitting device on shopping receptacle 110. At 608, shopping receptacle 110 transmits location information to shopping receptacle tracking system 104. At 610, shopping receptacle tracking system 104 locates shopping receptacle 110 in the store and determines the time spent at meaningful points in the store, such as an aisle, department, display, and so on. At 612, customer 602 checks out at POS system 108. At 614, customer interest engine 106 determines the merchandise purchased and the time spent at each meaningful point in the store, as received from shopping receptacle tracking system 104. At 616, customer interest engine 106 determines customer identification information, as received from shopping receptacle tracking system 104. At 618, customer 602 exits the store. At 620, a customer interest analysis can be performed by customer interest engine 106.

Thus, the flexibility of embodiments described herein allow for the deployment in almost any retail environment. Systems and methods can be implemented easily in any retail setting without the need for expensive and time-consuming customization of hardware and software (both customer interfacing and back-end).

Still other embodiments can provide additional features, such as tracking the movement of a shopping cart or other shopping receptacle without depending on a customer's mobile device.

Embodiments further do not require retail operators to charge or power the shopping receptacles, thereby saving employee time and power resources. In embodiments, the system is a green solution with 0% carbon footprint.

In embodiments, system 100 and/or its components or systems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the system or components thereof can comprise or include various modules or engines, each of which is constructed, programmed, configured, or otherwise adapted, to autonomously carry out a function or set of functions. The term “engine” as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. §112(f) are not to be invoked unless the specific terms “means for” or “step for” are recited in a claim.

1. A system for determining customer interests in a retail environment comprising:
a shopping receptacle module configured to be coupled to a shopping receptacle and comprising an energy capture portion and a communications portion, the energy capture portion comprising an energy storage device configured to receive and store energy generated by movement of the shopping receptacle, and the communications portion comprising customer identification circuitry and wireless transmitter circuitry and being electrically coupled with the energy storage device to receive power therefrom;
a shopping receptacle tracking system configured to be installed in the retail environment and comprising wireless communications circuitry configured to receive customer identification information and shopping receptacle location information from the wireless transmitter circuitry and track movement of the shopping receptacle in the retail environment over time; and
a customer interest engine communicatively coupled with a point-of-sale (POS) system in the retail environment and the shopping receptacle tracking system and configured to correlate data from the POS system with the customer identification information and the tracked movement of the shopping receptacle in the retail environment over time to identify at least one customer interest related to the retail environment for a customized follow-up action.

2. The system of claim 1, wherein the customized follow-up action is an offer to a customer for a product that the customer spent time near according to the tracked movement of the shopping receptacle in the retail environment over time but did not purchase according to the data from the POS system and the customer identification information.

3. The system of claim 1, wherein the product complements a product purchased by the customer according to the data from the POS system.

4. The system of claim 1, wherein the shopping receptacle is a shopping cart having wheels.

5. The system of claim 4, wherein the energy storage device is configured to receive and store energy generated by rolling of the wheels of the shopping cart.

6. The system of claim 1, wherein the customer identification circuitry comprises at least one of a magnetic stripe reader, a BLUETOOTH module, a WIFI module, a keypad, a radio frequency identification (RFID) module, a near-field communication (NFC) antenna, a biometric identifier, or a chip-and-pin module.

7. The system of 6, wherein the customer identification circuitry and the POS system are configured to receive information from a customer membership card associated with the retail environment.

8. The system of claim 6, wherein the customer identification circuitry is configured to communicate with a customer mobile device.

9. The system of claim 8, wherein the customer mobile device includes a mobile application associated with the retail environment.

10. The system of claim 9, wherein the customer interest engine is configured to be communicatively coupled with the mobile application.

11. The system of claim 1, wherein the wireless transmitter circuitry and the wireless communication circuitry communicate with one another using at least one of radio frequency (RF) communications, WIFI communications, BLUETOOTH communications, or near-field communications (NFC).

12. The system of claim 11, wherein the shopping receptacle module is configured to receive energy via the wireless communication circuitry.

13. A method for determining customer interests in a retail environment comprising:
providing a shopping receptacle module configured to be coupled to a shopping receptacle and comprising an energy capture portion and a communications portion, the energy capture portion comprising an energy storage device configured to receive and store energy generated by movement of the shopping receptacle, and the communications portion comprising customer identification circuitry and wireless transmitter circuitry and being electrically coupled with the energy storage device to receive power therefrom;
providing a shopping receptacle tracking system configured to be installed in the retail environment and comprising wireless communications circuitry configured to receive customer identification information and shopping receptacle location information from the wireless transmitter circuitry and track movement of the shopping receptacle in the retail environment over time; and
providing a customer interest engine communicatively coupled with a point-of-sale (POS) system in the retail environment and the shopping receptacle tracking system and configured to correlate data from the POS system with the customer identification information and the tracked movement of the shopping receptacle in the retail environment over time to identify at least one customer interest related to the retail environment for a customized follow-up action.

14. The method of claim 13, further comprising coupling the shopping receptacle module to the shopping receptacle.

15. A method for determining customer interests in a retail environment comprising:
associating a customer with a shopping receptacle;
tracking movement of the shopping receptacle in a retail environment during a period of time, wherein the movement generates energy that is captured and used by at least one electrical device mounted on the shopping receptacle;
correlating data from a purchase made in the retail environment by the customer with the tracking based at least in part on data obtained in the associating; and
identifying, from the correlating, at least one customer interest related to the retail environment for a customized follow-up action.

16. The method of claim 15, wherein the at least one customer interest is a product that the customer spent time near but did not purchase according to the correlating, and wherein the method further comprises providing an offer to the customer for the product.

17. The method of claim 15, wherein the associating comprises receiving information identifying the customer as a member of the retail environment.

18. The method of claim 15, wherein the correlating further comprises receiving the data from a point-of-sale (POS) system in the retail environment.

19. The method of claim 18, further comprising identifying the customer at the POS system.
